(19) United States
(12) Patent Application Publication
(10) Pub. No.: US 2007/0063375 A1
(43) Pub. Date: Mar. 22, 2007

(54) Process for creating adhesion elements on a substrate material

(76) Inventor: Jan Tuma, Herrenberg (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/577,233

(22) PCT Filed: Mar. 20, 2004
(86) PCT No.: PCT/EP04/02963

§ 371 Date: Apr. 26, 2006

(30) Foreign Application Priority Data
Mar. 12, 2004 (DE) 10 2004 012 067.6

(51) Int. Cl. B29C 47/32

(52) U.S. Cl. 264/166; 264/167; 264/210.1

(57) ABSTRACT

The invention relates to a process for creating adhesion elements on a substrate material (10) using at least one plastics material which is introduced into at least one shaping element (12). By producing adhesion elements with flared ends which adhere primarily as a result of van der Waals forces, the excellent adhesion characteristics of a gecko's foot are achieved in a biomechanical model without having to separate the setae fibres as in nature.

The invention relates to a process for creating adhesion elements on a substrate material by using at least one plastic material which is introduced into at least one shaping element.

WO 94/23610 A1 discloses a process for producing an adhesion closure part in which a substrate having a plurality of stems which are preferably connected integrally to it is prepared. Especially the formation of an adhesion closure for baby diapers or hospital clothing is disclosed as one possible application of an adhesion closure part produced in this way. To produce adhesion closure parts which can be used in adhesion closures for these articles of clothing, a relatively large number of interlocking means per square centimeter is needed; this leads to correspondingly high production costs, since the forming rolls used to form the interlocking means in the prior art must have a corresponding number of cavities which can only be stamped with great effort. The adhesion closure parts produced in this way have stems which project in the vertical direction, which are arranged integrally on a film-like substrate material, which on their free end are provided with head-side flare, and which to produce the detachable adhesion closure interact with a corresponding fleece or pile material which interlocks mechanically with the underside of the head-side flare of the stem material. These closure systems in the German-speaking world are often advertized with the trademark label Kletten® adhesion closures [velcro-type fasteners]. The disadvantage of these Kletten® adhesion closure systems is that for effective adhesion, therefore to form the actual adhesion closure, they must always interact with the corresponding closure parts (fleece or pile fabric), modern closure systems currently also being able to join identically made head closure parts to one another with formation of an adhesion closure by the head-side ends of one closure part engaging the spaces between the head-side ends and stems of the other closure part, and the head parts which are radially flared compared to the stems then mutually interlock, with their edge surfaces facing one another, these closure systems also being made detachable.

Furthermore, the prior art discloses processes for producing fibrillated polypropylene or polyethylene films (DE 198 37 498 A1, U.S. Pat. No. 6,432,347 B1) in which using existing plant equipment (film extrusion units for flat film, blown film or for use of chill-roll processes) by special measures in technology and on the equipment, films can be complexly stretched, fibrillated and wound without division into strips and thus a net-like film with varied width and great length can be produced. As a result of monoaxial stretching in this known approach improved molecular fiber orientation occurs and the fabrics which can be produced in this way are used as geotextiles or in construction as reinforcement. Furthermore, in German patent disclosure document 1 175 385 and in U.S. Pat. No. 6,432,347 fibrillation of film material by using a swirl nozzle and with a pulsed water jet with high pressure is described, in order in this way to arrive at improved filter material or a film-like material with improved thermal and acoustic insulation properties.

In order to achieve new effects in connection technology relative to adhesion closure parts, in DE 103 25 372 A1 which was published afterwards it was proposed for an adhesion closure part that at least one part of the free ends of the stems of the adhesion closure material be provided with a host of individual fibers, the diameter of the respective fibers being chosen to be very thin, so that on the free end of each individual fiber only a very small contact surface is available, for example on the order of 0.2 to 0.5 μm In preferred embodiments, the thickness range of this structure in the form of stems to which individual fibers are connected can also be in the nanometer range, for example 100 to 400 nanometers. These orders of magnitude are sufficient for an interaction with the corresponding part (surface) on which the adhesion closure part is to be fixed to be able to take place via so-called van-der-Waals forces.

Van-der-Waals forces are intermolecular forces which occur as weak binding forces between inert atoms and saturated molecules and which are called van-der-Waals. While in the interaction between atoms only so-called dispersion forces take effect, in molecules the interactions of induced or possibly present permanent dipole moments (orientation effects) are active as additional forces of attraction. It should be pointed out that many authors consider van-de-Waals forces as a synonym for intermolecular forces, but that for most van-der-Waals forces are defined as very wide-reaching attraction forces between neutral molecules with energy which decreases with the 6th power of the molecular distance. The forces can be for example actively observed in host-guest relations in molecular lattice crystals, inclusion compounds, molecular compounds and in phenomena of colloid chemistry, interface and surface chemistry (compare RÖMPPS CHEMIE LEXIKON, 8th edition, Frankh'sche Verlagshandlung Stuttgart).

To obtain these individual fibers, on a strip-like substrate part, first of all projecting cylindrical stems are produced from plastic material and are obtained from a forming roll process by means of a screen, a calendering process or without mold tools via a droplet application process and then the stem ends are chemically, mechanically or electrically divided into individual filaments or individual fibers. The adhesion closure part or adhesion element obtained in this way finds its counterpart in nature, for example on a gecko's foot enabling a gecko, owing to the configuration of its feet, to walk on a ceiling or also along vertically running glass surfaces. These bristles, which are present in thousands on a gecko's foot, are called “seta” in technical language, and the individual fibers or individual filaments adjoining the free bristle end are called “spatula”.

Thus WO 01/49776 A1 proposed taking the seta elements from a living object to build adhesion closure parts and to join them to a carrier part as a substrate, forming processes with pipetting technology and modern pressure processes being intended as replacement production processes. Comparably, WO 03/095190 A1 proposes that the seta elements be prepared by way of a first shaping template congruently connected to a second shaping template for forming the spatula. In addition to problems of mold removal, in the indicated template technique it is only suitable within the framework of laboratory implementation in the same manner as the other indicated processes relative to the artificial imitation of the gecko foot structure. Use of van-der-Waals forces for an adhesion closure part or an adhesion part is not possible on a large industrial scale with these processes.

Proceeding from this prior art, the object of the invention is to further improve the known production processes for producing adhesion elements which adhere based on van-der-Waals force such that they can be economically produced on a large industrial scale and still extensively develop an adhesion action. This object is achieved by a process with the features of claim 1 in its entirety.

Because with the process as claimed in the invention adhesion elements can be produced with flared ends, the adhesion of which is accomplished predominantly by means of the indicated van-der-Waals forces, the very good adhesion values of a gecko's foot as a biomechanical model are achieved without defibrillation of the adhesion stems having to take place according to constraints in nature. It is surprising to one with average skill in the art in the area of closure technology that with rejecting the adopted approach of having to identically imitate nature he arrives at very good adhesion properties, produced mainly by van-der-Waals force, in which there are flared end surfaces on the stem ends without defibrillation.

This adhesion part can be very economically produced on a large industrial scale and fundamentally can be detachably joined to any surface (substrate) in order in this way to join for example a body part provided with adhesion elements to a vehicle frame or in this way to hang a picture or display screen on a wall without other connectors by the adhesion elements interacting with their flared ends directly with the surface by way of the indicated van-der-Waals forces.

If the adhesion element part produced using the process as claimed in the invention is used in the clothing industry, no further modifications are necessary, especially there need not be pile or fleece material on clothing parts in order in this way to ensure interlocking with the otherwise conventional adhesion closure parts (mushroom or hook). Rather here the closure part with the adhesion elements can interact via the free flared ends with the material of the clothing fabric to produce a connection. It has been found that to detach the adhesion elements from the surface they are preferably peeled off the surface best at an angle of 90° in order in this way to release the interlocking by way of van-der-Waals forces and to be able to remove the closure from a surface of any nature again. These attachment and release processes can take place repeatedly, depending on the configuration of the closure systems, preferably several thousand times.

To produce the closure or preferred connection it is sufficient to place the adhesion elements with the free flared ends of the otherwise stem-shaped adhesion elements flat on the surface. Preferably it is provided that the length of the adhesion elements is selected such that for each stem via their free ends they end in a common plane, since the van-der-Waals forces act only over an extremely short distance so that preferably it can be provided that the distance of the free contact ends of the flared ends of the individual stems to the intended surface is essentially constant. To prevent the adhesion elements from being able to kink away from the surface with which contact is to made, they have relative inherent stiffness; but in order to be able to ensure good release behavior, it can be provided that the flared ends by way of a corresponding reduction in diameter in the transition area to the stem are connected to the latter in this manner. In this way at the transition point a type of joint is formed so that the strip-like substrate part with the stems is peeled off and the still adhering surface end head follows the peeling motion in the sense of unrolling motion by way of the respective joint.

Adhesion results have been very good if there are roughly 16,000 adhesion elements per cm² substrate material, the individual adhesion elements then having only a size, especially a height, of roughly 100 μm and smaller, with a diameter of the flaring head end of roughly 60 μm or smaller.

Other advantageous embodiments of the process as claimed in the invention are the subject matter of the other dependent claims.

The process as claimed in the invention is detailed below using an adhesion element obtained with it according to the drawings which are schematic and not to scale.

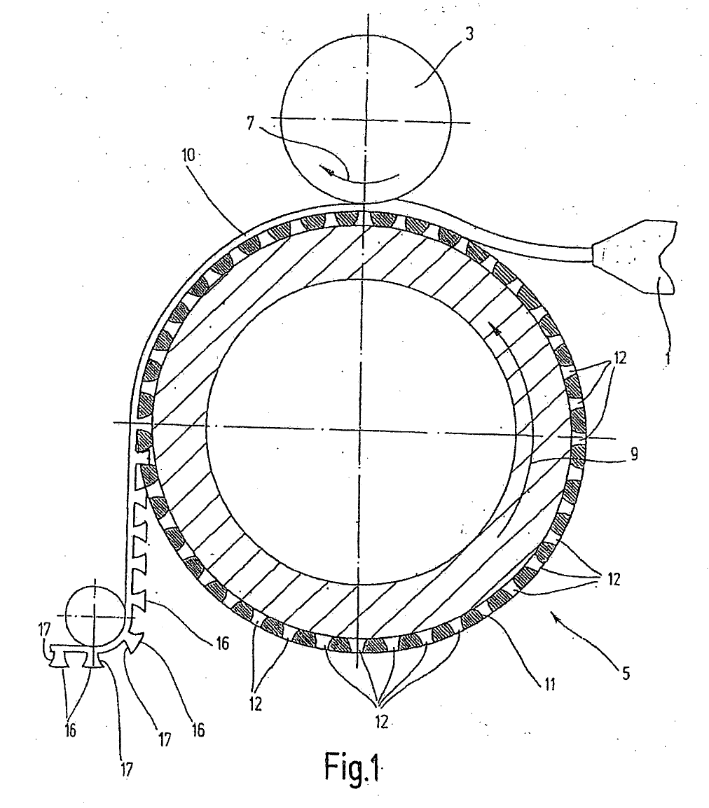

FIG. 1 shows a side view of a device for carrying out the process as claimed in the invention;

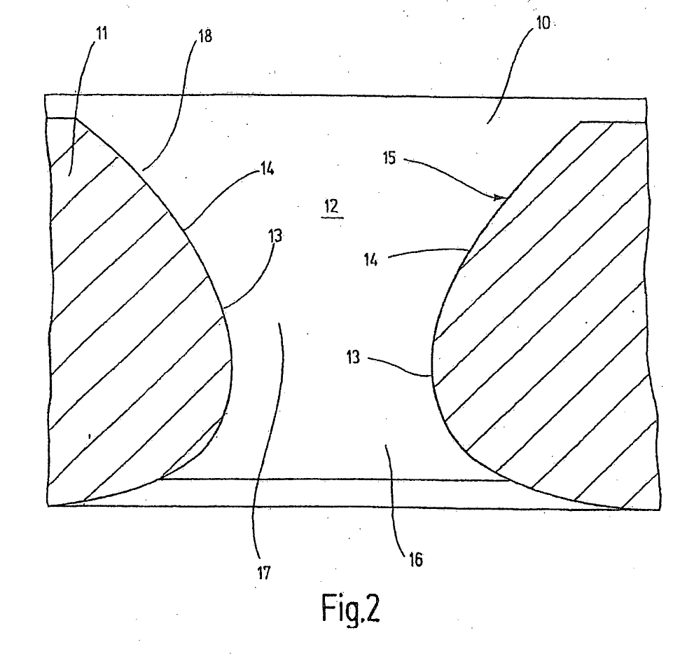

FIG. 2 shows highly enlarged a lengthwise section through a mold cavity according to FIG. 1;

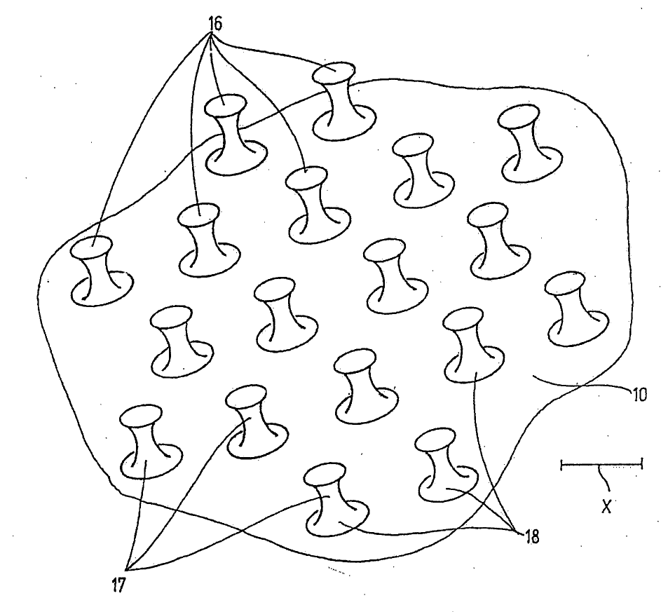

FIG. 3 shows highly enlarged the adhesion elements located on a substrate material, produced with the process as claimed in the invention.

The initial product of adhesion elements which is shown in FIG. 3 for purposes of this invention can be obtained for example using a process as is described in DE 100 39 937 A1.

FIG. 1 schematically shows parts of a device for carrying out the process as claimed in the invention with a nozzle head 1 as the supply means for plastic or liquid and thixotropic plastic which is supplied as a strip with a width corresponding to that of the adhesion element part to be produced, to the gap between a pressure tool and a molding tool. As shown in FIG. 1, the pressure tool is a compression roll and the molding tool is a forming roll which is labelled 5 overall. Both rolls are driven in the directions of rotation indicated in FIG. 1 with curved arrows 7 and 9 so that a delivery gap is formed between them, through which the plastic strip is conveyed in the transport direction, while at the same time in the gap as the shaping zone the plastic strip is formed into a substrate 10 as the substrate material of the adhesion closure elements and the substrate 10 on the side adjoining the forming roll 5 acquires the shaping required to form the adhesion elements by the shaping elements of the forming roll 5.

For this purpose the forming roll 5 on the periphery has a screen 11 with individual mold cavities 12. One such mold cavity as a shaping element is shown enlarged in FIG. 2 as an example. The inflow direction of the plastic material takes place, viewed in the direction of looking at FIG. 2, in the area of the pressure roll 3 from top to bottom. Furthermore, the mold cavities 12, not detailed, are regularly distributed on the outside periphery over the forming roll 15 with its screen 11, the distribution and number being optional, but preferably more than 10,000 of these mold cavities per mm² being located on the screen, and a figure of 16,000 mold cavities 12 per cm² has proven especially favorable for making the adhesion elements. FIG. 2 shows a longitudinal section again of the respectively used mold cavity 12, the boundary walls 13 opposite in the longitudinal section being provided continuously with a convex shape 14. It goes without saying that these two boundary walls 12 with respect to the rotationally symmetrical structure of the mold cavity 12 are fundamentally part of a terminal shaping wall 15 which is bordered by the screen material 11 of the forming roll 5. With these mold cavities 12 it is possible to produce adhesion elements in the form of a stem part 17 provided with a head part 16 as the flared end.

As FIG. 2 furthermore shows, the curvature of the respective shape 14 in the direction of the head part 16 to be formed is greater than in the direction of the base part 18 via which the stem part 17 is connected to the substrate 10. It has proven especially advantageous if, viewed from the lengthwise direction of the stem part 17 in the direction of the head part 16, the shape 14 is provided with its greater curvature beginning above the middle, preferably in the upper third.

To obtain the indicated mold cavities 12 with their rotationally symmetrical structure in the form of a hyperboloid, galvanic coating processes, especially electroplatinizing processes, have proven effective, in which first a cylindrical mold cavity (not shown) is coated with a coating material or platinized until the convex shape 14 is established. Furthermore, optionally the convex shape 14 can also be produced from a screen or solid grate material via a laser process or an etching process.

The adhesion parts shown in FIG. 3 can be obtained with the above described process and device. The symmetrical structure arises directly by production in a mold cavity 12 as shown in FIG. 2. Instead of the illustrated device as shown in FIG. 1, the compression roll 3 can be replaced by a doctor tool (not shown) which delivers the plastic material into the mold cavities 12 directly in the sense of a doctor process. The cylindrical screen structure can also form a strip which runs peripherally between two cylindrical drive rolls (not shown), then in turn the plastic material preferably being doctored onto the strip surface. If the plastic materials can be crosslinked, moreover a heat source or UV light (not shown) can enable re-crosslinking as soon as the adhesion elements have been removed from the mold cavities 12. This re-crosslinking is conventional so that it will not be detailed here. But preferably in a shaping process by means of a perforated strip there is crosslinking with the indicated means, at least on the side directly in the mold cavities 12.

In order to obtain an optimum with respect to van-der-Waals forces, preferably the free, flared head ends as the head part 16 should run flat to the outside. Since the individual mold cavities 12 are sealed to the inside by the forming roll 5, in this respect it would not be precluded that the air enclosed there in the forming process would press a concave air cushion into the free head part end. To counteract this, it can be provided that within the forming roll 5 there is a means which allows the air to escape or which enables suction of the air in the mold cavity 12, for example via a vacuum means or the like. But in the latter case a corresponding trigger device is necessary to induce vacuuming in a directed manner and to prevent the flat head ends from bulging in the direction of the forming roll 5, but a slight convex curvature of the free head not being harmful. How the stem and head configuration appears in cross section is shown in FIG. 2. The plastic material is displaced into the mold cavity 12 and comes to rest there and then forms the flat outer side of the head. In this respect the plastic material hardens in the mold itself and is then removed from the mold cavity 12 in the pre-hardened state or is already for the most part hardened in it, in any case only to the extent the mold removal process is not adversely affected. The middle constriction due to the shaping of the hyperboloid of rotation can be continued such that for a further narrowed point a type of joint between the stem part 17 and the head part 16 forms. This hinge, as already mentioned, is favorable for the action of the van-der-Waals closure system.

Suitable plastic materials are inorganic and organic elastomers, especially polyvinyl siloxane, and addition-crosslinking silicone elastomers, also in the form of binary systems and acrylates. The use of rubber materials is also possible.

The process can be made especially advantageous when the plastic material used at the time is thixotropic. Thixotropic behavior in the sense of the invention means reducing the structural thickness during the shear loading phase and its more or less rapid but complete re-establishment during the subsequent resting phase. The breakdown/build-up cycle is a completely reversible process and thixotropic behavior can be defined as a time-dependent behavior. Furthermore, plastic materials have proven especially advantageous in which a viscosity of 7000 to 15000 mPas measured with a rotary viscosimeter is sufficient, but preferably has a value of roughly 10000 mPas at a shear rate of 10 l/sec. In the sense of a self-cleaning surface it has moreover proven to be advantageous to use plastic materials with a contact angle which has a value of greater than 60 degrees due to their surface energy for wetting with water. Under certain circumstances this surface energy can also be further changed by subsequent coating processes.

In order to illustrate the size (height) relationships of the adhesion element material obtained, in FIG. 3 X indicates the length which corresponds to a size of roughly 100 μm. The geometrical dimensions of the adhesion elements are given below, the indicated orders of magnitude for better illustration not being reflected directly in FIG. 3 which shows in this respect only fundamentally the structure of the adhesion element material. In one preferred embodiment of the adhesion element material as claimed in the invention there are more than 16,000 adhesion elements on one cm² of substrate material 10. From the top of the substrate 10 to the termination of the adhesion element over the flat head top each adhesion element has a height of roughly 100 μm; this corresponds to the magnitude scale of X as shown in FIG. 3. The flat head tops have a diameter of roughly 50 μm and decrease in the direction to the top end of the stem part 17 (joint) to a size of roughly 30 μm. In this respect, between the head part 16 and stem part 17 an undercut is formed instead of a transition. The height of the head part 16 is roughly 10 μm and the size of the radial projection of the head part 16 to the top end of the stem part 17 is roughly 10 μm. The distances between the boundaries of adjacently opposite head parts 16 is roughly 30 μm to 40 μm. The diameter of the stem part 17 is roughly 20 tun to 35 μm. These size relationships are only exemplary and can be changed within the indicated framework of sizes, in any case its necessarily being ensured that relative to the stem parts 17 the head part 16 has a flat or slightly convex surface which enables the action of van-der-Waals forces if the adhesion element part comes into contact with a surface of any type. For the adhesion element part which can be produced on a large technical scale, due to the nano configuration of the adhesion elements they can no longer be detected with the naked eye and it is surprising that very reliable detachable adherence via van-der-Waals forces takes place due to the structure of the adhesion element.

Both the head cross sections and also the stem cross sections can be angular, especially provided with a hexagonal cross sectional shape, and the aspect ratio of each adhesion element is preferably between 1:3 and 1:5. With the process as claimed in the invention, adhesion elements on a closure characteristic by means of van-der-Waals forces can be economically and reliably made available on a large industrial scale.

1. Process for creating adhesion elements on a substrate material (10) by using at least one plastic material which is introduced into at least one shaping element (12), characterized in that in this way adhesion elements with flared ends are formed with adhesion which is accomplished predominantly by means of van-der-Waals forces.

2. Process as claimed in claim 1, wherein plastic materials can be inorganic and organic elastomers, especially polyvinyl siloxane, and addition-crosslinking silicone elastomers, also in the form of binary systems and acrylates.

3. Process as claimed in claim 1, wherein the plastic material used at the time is thixotropic and has a viscosity of 7,000 to 15,000 mPas measured with a rotary viscosimeter, but preferably has a value of roughly 10,000 mPas at a shear rate of 10 l/sec.

4. Process as claimed in claim 1, wherein as the respective shaping element a drum-shaped or strip-shaped screen (11) is used which is provided with at least 10,000, but preferably with 16,000 mold cavities (12) per cm².

5. Process as claimed in claim 4, wherein the respective mold cavity (12) is made in the manner of a hyperboloid.

6. Process as claimed in claim 1, wherein the plastic material is one with a contact angle which has at least a value of greater than 60 degrees, preferably greater than 70 degrees, due to the surface energy for wetting with water.

7. Process as claimed in claim 1, wherein the flared ends of the adhesion elements are made essentially flat or slightly convex.

8. Process as claimed in claim 1, wherein the respective adhesion element is formed from a stem part (17) with a height from 50 μm to 150 μm, preferably of roughly 90 μm, and a diameter from 10 μm to 40 μm, preferably of roughly 30 μm, and wherein the flared ends as the head parts (18) on the stem parts (17) have a diameter from 15 μm to 70 μm, preferably of roughly 50 μm.

9. Process as claimed in claim 1, wherein for crosslinkable plastic materials they are re-crosslinked with or after preparation of the adhesion elements, for example with UV light.
